(19) United States
(12) Patent Application Publication
(10) Pub. No.: US 2007/0242066 A1
(43) Pub. Date: Oct. 18, 2007

(54) Virtual video camera device with three-dimensional tracking and virtual object insertion

(76) Inventor: Patrick Levy Rosenthal, Paris (FR)

Correspondence Address: OLIFF & BERRIDGE, PLC, P.O. BOX 19928, ALEXANDRIA, VA, 22320, US

(21) Appl. No.: 11/783,995

(22) Filed: Apr. 13, 2007

Related U.S. Application Data
(60) Provisional application No. 60/791,894, filed on Apr. 14, 2006.

(51) Int. Cl. G06T 15/00

(52) U.S. Cl. 345/419

(57) ABSTRACT

A method and apparatus are described that provide a hardware independent virtual camera that may be seamlessly integrated with existing video camera and computer system equipment. The virtual camera supports the ability to track a defined set of three-dimensional coordinates within a video stream and to dynamically insert rendered 3-D objects within the video stream on a real-time basis. The described methods and apparatus may be used to manipulate any sort of incoming video signal regardless of the source of the video. Exemplary application may include real-time manipulation of a video stream associated, for example, with a real-time video conference generated by a video camera, or a video stream generated by a video player (e.g., a video tape player, DVD, or other device) reading a stored video recording.

### CROSS-REFERENCE TO RELATED APPLICATION

This application claims priority to U.S. Provisional Application No. 60/791,894 filed on Apr. 14, 2006, the disclosure of which, including all materials incorporated therein by reference, is incorporated herein by reference in its entirety.

### BACKGROUND

1. Field of Invention

The present invention pertains to the real-time manipulation of video images.

2. Description of Related Art

The use of video cameras has increased dramatically in recent years. Further, with significant increases in Local Area Network (LAN) data bandwidth, Wide-Area-Network (WAN) data bandwidth and Internet data bandwidth, the use of video cameras in connection with data networks to support video conferencing, IP telephony, and other applications has also greatly increased. Hence, an approach is needed to facilitate the manipulation of video streams to enhance the presentation of video graphics in a wide range of user video based applications.

### SUMMARY

A method and apparatus are described that provide a hardware-independent virtual camera that may be seamlessly integrated with existing video camera and computer system equipment. The virtual camera supports the ability to track one or more defined sets of three-dimensional coordinates associated with image content within a video stream. Further, the virtual camera allows virtual 3-D objects to be inserted within the video stream, on a real-time basis, based upon the tracked sets of 3-D coordinates.

The described methods and apparatus may be used to manipulate any sort of incoming video signal regardless of the source of the video. Exemplary applications may include real-time manipulation of a video stream generated by a video camera associated with, for example, a real-time video conference, or may include real-time manipulation of a video stream generated by a video player (e.g., a video tape player, DVD, or other device) reading a stored video recording.

In one exemplary embodiment, a physical camera may be connected to a computer and used to capture a stream of video images associated with a video conference to a video storage buffer. Virtual camera control software may be executed by the computer and may retrieve images from the video storage buffer and send the stream of video images to two subprocesses.

The first subprocess may be a human facial feature tracking process that is able to detect a position and generate 3-D (e.g., X, Y and Z) coordinates for several points associated with a feature of a user's face positioned in front of the video camera. Such facial features may include a user's nose, eyes, mouth, etc. The facial feature tracking software may generate coordinates for each user's facial features based on algorithms designed to detect the orientation of the user face in logically simulated 3-D coordinates. The generated facial feature coordinates may be stored as a matrix of data using a predetermined data structure.

The facial feature tracking process may send facial feature matrix data to a 3-D feature visualization subprocess (or 3-D engine). The 3-D engine may receive the facial feature matrix data in near real-time, and may track the user facial features, head rotation and translation in the video based upon the received facial feature matrix data. Further, the 3-D engine may insert virtual 3-D video objects into the video stream based upon the received facial features data matrix and a list of virtual objects identified by a user for insertion into the data stream. These virtual objects may be selected from a gallery tool bar and may include, for example, a virtual mouth, glasses, hat or more specifically small 3-D objects.

Insertion of such components within a video conference video stream is in some ways similar to the use of “Emoticons” (e.g., :), ;), :−), etc.) in text chat. However, exemplary virtual video objects that may be included in exemplary embodiments of the invention may include, for example, hearts, tears, dollar signs rotating in a user's eyes, guns going out of the user's eyes and shooting bullets, etc. Such 3-D effects allow the user to express emotions in the video. The 3-D engine may also add special effect sounds to modify the voice in real time and may synchronize the lips of a virtual mouth with the real user mouth based on the audio stream. The 3-D engine may send back a buffer to the virtual camera control software with the original image augmented with the objects that rotate and move with the user face in 3-D. The virtual camera controller may send the resulting stream of video data to a virtual camera device defined within the operating system of a computer system that may be accessed by user applications such as ICQ Messenger, Skype, ICQ, AOL Messenger, Yahoo Messenger, or any other software capable of connecting to a physical video camera or other video input stream.

The described approach allows implementation of virtual cameras as overlays to existing physical camera and/or other video input devices, via a standard operating system device interface. For example, if a user were to select in his, or her, Messenger software the virtual camera instead of the real camera as a video tool, the user would be able to send to his or her friends a video of his or her face including inserted virtual objects; the user can also send short video messages that include inserted virtual objects by email to friends. The virtual camera control software may be independent of device hardware and operating system software and thus fully compatible with all of them. A single version of the virtual camera control software allows both chatters in a video conference to see virtual objects embedded within the video, thereby providing exposure of the product to a potential base of new users, and thereby allowing a maximal “viral” download effect among users.

Exemplary embodiments of the described virtual camera executing on a local computer system may support a bi-directional data interface with a virtual camera embodiment executing on a remote computer system. Such a bi-directional data interface may support a wide range of interactive capabilities that allow injected content and characteristics to be controllably passed across virtual camera video streams in support of interactive gaming. Further, such a bi-directional interface may also be used to support the simultaneous control an operation of local hardware devices by computer systems at remote locations connected via a network, based on the relative position of objects dynamically tracked features within virtual camera and/or physical camera video streams.

Use of the described virtual camera approach is not limited to any particular end-application application. For example, depending upon the features that the video feature tracking system can detect within a video stream, the tracking process may be configured to detect a wide range of features. Such features are not necessarily limited to facial features. For example, the described approach may be applied to the visualization of geospatial imaging data; astronomy; remote-video surgery, car, truck, tank and/or aircraft maintenance and/or any number of user applications.

### BRIEF DESCRIPTION OF THE DRAWINGS

Exemplary embodiments are described below with reference to the attached drawings, in which like reference numerals designate like components.

FIG. 1 is a schematic diagram of a network based video conferencing system;

FIG. 2 is a schematic diagram depicting connectivity between a video camera and a network enabled user application;

FIG. 3 is a schematic diagram depicting connectivity between a video camera and a network enabled user application in accordance with an exemplary embodiment of the described virtual camera;

FIG. 4 is a schematic diagram depicting connectivity between a video camera and a network enabled user application and depicting exemplary real-time 3-D tracking and real-time dynamic video signal processing capabilities in accordance with an exemplary embodiment of the described virtual camera;

FIG. 5 is an exemplary described user interface that may be used to control real-time 3-D tracking and real-time video content insertion in accordance with an exemplary embodiment of the present invention;

FIG. 6 is an exemplary generated virtual camera view as may be viewed by selecting the virtual camera as the source camera from within Microsoft Messenger;

FIG. 7 is a flow diagram representing an exemplary method for generating a virtual camera video stream that includes real-time video content insertion based on the exemplary virtual camera of FIG. 4.

FIG. 8 is a schematic diagram of system that includes exemplary virtual camera embodiments that supports a bi-directional exchange of information between virtual cameras executing on computer systems connected via a network;

FIG. 9 is a schematic diagram of a feature tracking engine described above with respect to FIG. 8;

FIG. 10 is a schematic diagram of a encoding/decoding engine described above with respect to FIG. 8;

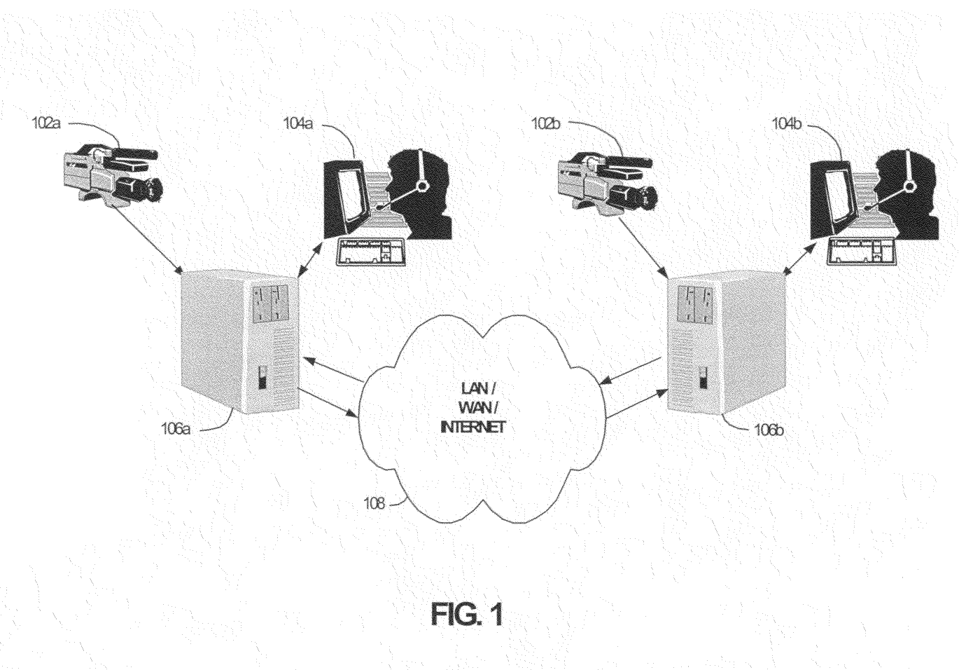

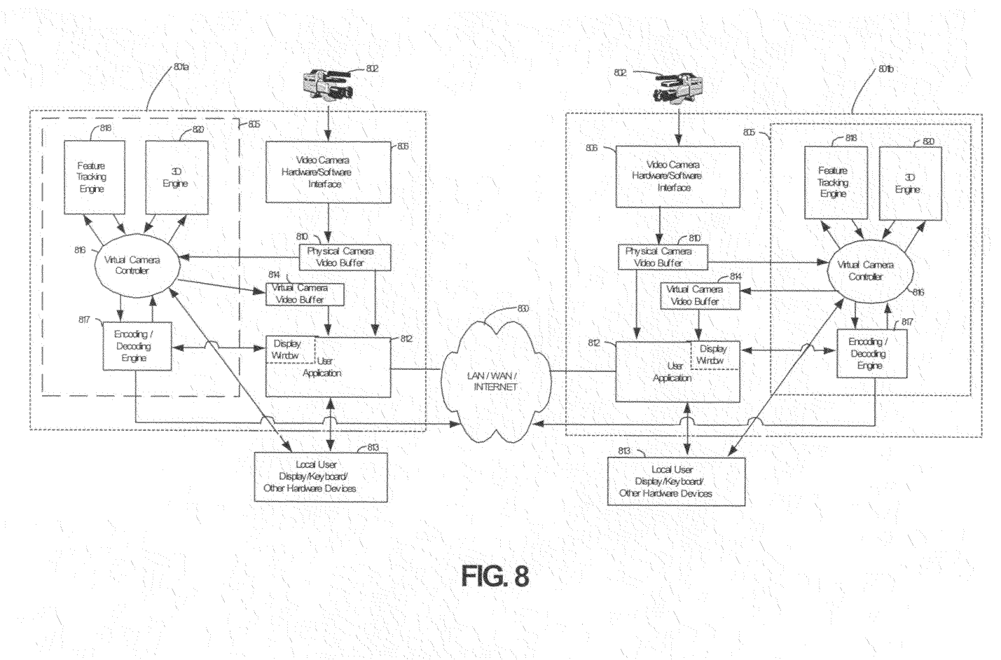

FIG. 1 presents an exemplary pixel encoding technique that may be used to encode information within a video frame image within a stream of video frame images generated by the virtual camera embodiments described above with respect to FIGS. 8-10;

FIG. 12 presents an exemplary virtual camera view that includes data encoded within the video frame image;

FIG. 13 presents a close up of the encoded data portion of the video frame image presented in FIG. 12; and

FIGS. 14 and 15 are a flow diagram representing processing performed by a virtual camera embodiment that supports a bi-directional data interface, as described with respect to FIG. 8-13.

### DETAILED DESCRIPTION OF EMBODIMENTS

FIG. 1 is a schematic diagram of an exemplary network based video conferencing system. As shown in FIG. 1, a first camera 102a of a first user 104a using computer system 106a may generate a video signal of first user 104a and may send the video signal via LAN/WAN/Internet 108 to user 104b using computer system 106b. The second user 104b may be connected to LAN/WAN/Internet 108 to receive the video from first user 104a, and the second user's camera 102b may be used to send video to first user 104a via computer 106b.

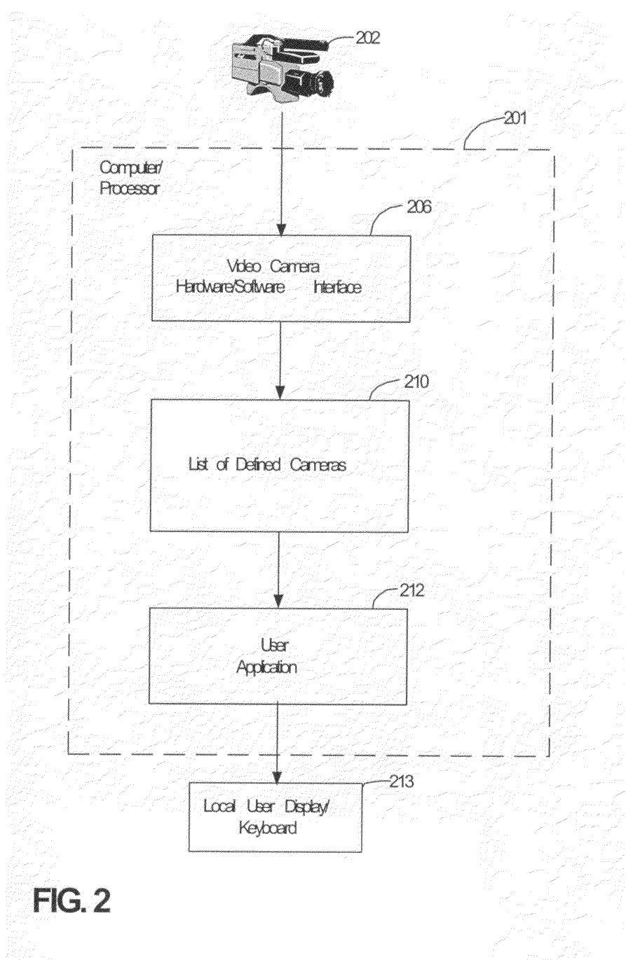

FIG. 2 is a schematic diagram depicting connectivity between a video camera and a network enabled user application not using the described virtual camera. As shown in FIG. 2, video camera 202 may connect to computer system 201 via a hardware/software interface 206. Hardware/software interface 206, that may include, for example, a physical data transmission path between the camera and computer system 201, such as a universal serial bus (USB) cable or other cable, or an infrared or radio based physical data transmission path, etc., that connects to a compatible port, e.g., USB or other cable port, infrared receiver, radio wave antenna, etc., on computer system 201.

Computer system 201 may include hardware/software that supports a predetermined communication protocol over the physical data transmission path, as well as device specific drivers, e.g., software drivers, that may allow the attached video camera to be made available for selection by a user application 212, by presenting video camera 202 in a list of defined cameras that may be selected by any one of user applications 212. Once a defined physical camera is selected by a user device, any video stream generated by the selected camera may be passed to (or piped) to the selecting user application. A user may interact with the one or more user applications via display/keyboard combination 213.

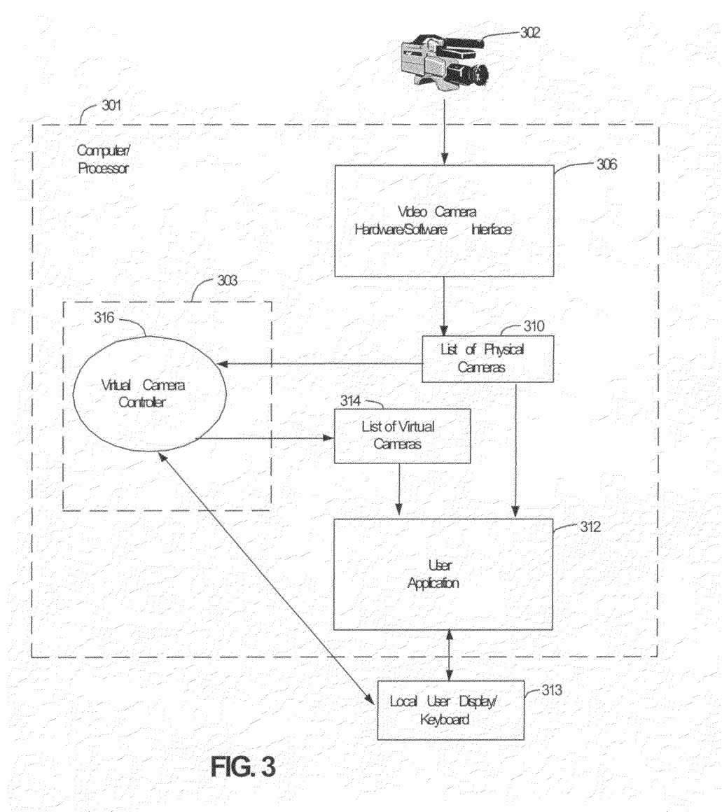

FIG. 3 is a schematic diagram depicting connectivity between a video camera and a network enabled user application in accordance with an exemplary embodiment of the described virtual camera. As shown in FIG. 3, connection of a physical camera to a user application device remains practically unchanged from the perspective of the physical camera device 302 and user application 312. Physical camera 302 may continue to connect to computer system 306 via a physical data transmission path and a device driver specific to the camera manufacture/camera used, user applications may continue to select a camera from a list of available cameras, and a user may interact with the one or more user applications via display/keyboard combination 313. In this manner, use of the virtual camera control software is transparent to all physical video stream devices and user applications.

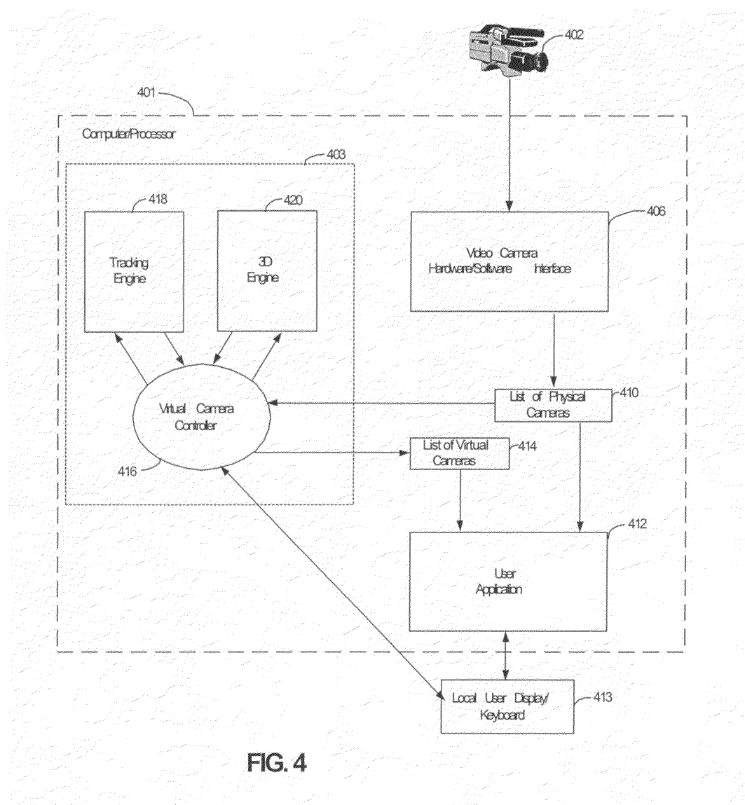

However, as shown in FIG. 3, control software 316 within virtual camera 303 selects one or more physical cameras from a list of defined physical cameras 310 and redirects the video buffers from these devices to the virtual camera controller 316. As discussed in greater detail with respect to FIG. 4, below, the virtual camera controller may present a user application 312 with a “virtual camera” for each physical camera redirected to the virtual camera controller. If a user application 312 chooses one of the virtual cameras listed in the virtual camera list 314, the video stream fed to the user application is a processed video stream that may have been configured by the virtual camera control interface to include injected virtual objects, as discussed in greater detail below with respect to FIG. 4. Further, a virtual camera listed in virtual camera list 314, when selected by a first user application, is not locked from use by other user applications. Such a feature may be implemented, for example, using a directshow filter within the Microsoft DirectX/DirectShow software development environment. Therefore, a virtual camera listed in virtual camera list 314 may be selected for use by more than one application, simultaneously. For example, once a virtual camera is defined and listed in virtual camera list 314, multiple user applications (e.g., ICQ Messenger, Skype, ICQ, AOL Messenger, Yahoo Messenger, or any other user application) may select the same virtual camera and each selecting application may receive a video stream from the selected virtual camera. Such user applications 312 may present one or more virtual camera video streams and/or other video streams received from other sources, e.g., from a physical camera selected from list of physical cameras 310, or from a network connection to a remote computer system executing the same user application, to a display, such as display/keyboard combination 313.

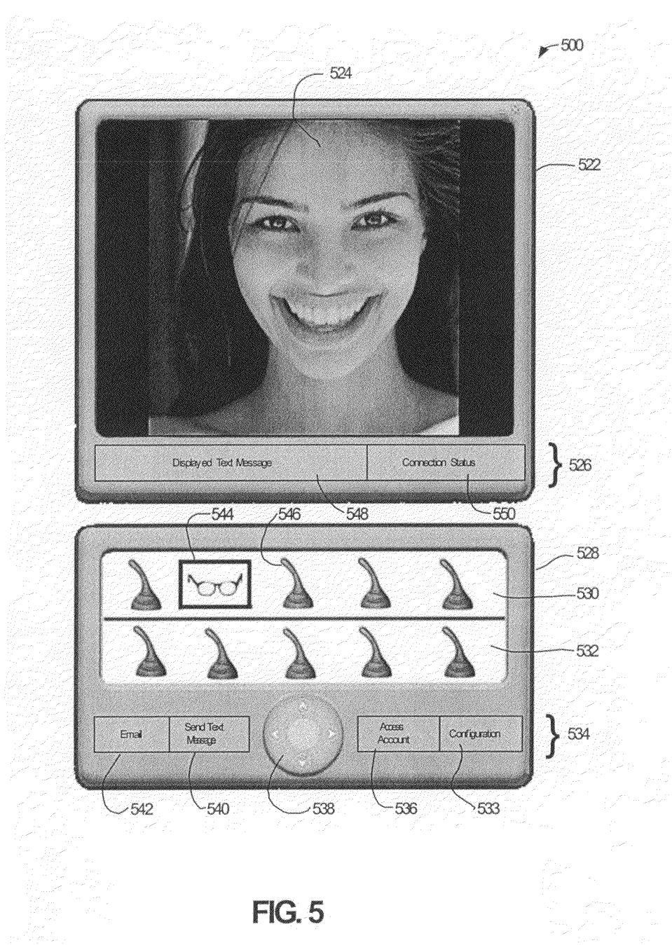

FIG. 4 is a schematic diagram depicting connectivity between a video camera and a network enabled user application and depicting exemplary real-time 3-D tracking and real-time 3-D engine processing capabilities in accordance with an exemplary embodiment of the described virtual camera 403. As shown in FIG. 4, the virtual camera controller 416 (e.g., control software) may connect to a camera 402 connected to computer system 401 via video camera hardware/software interface 406 and listed in the list of defined physical cameras 410, thereby locking the file for use. The virtual camera controller 416 may then copy the video stream in a buffer and may send it to face tracking engine 418. The face tracking engine 418 may scan the video for facial features and may return to virtual camera controller 416 a matrix of facial feature coordinates. Next, virtual camera control software 416 may send the matrix of facial feature coordinates to the 3-D engine 420. Based upon the features selected for insertion within the video, as described below with respect to FIG. 5, and the received facial feature coordinates matrix data, the 3-D engine may generate appropriate 3-D views of the selected injected content and may insert the generated content at an appropriate location within the received video stream. Next, virtual camera controller 416 may output the modified video stream to a virtual camera output video buffer associated with a virtual camera defined in a list if virtual cameras 414 that may be accessible to user applications 412. Such user applications 412 may present one or more virtual camera video streams and/or other video streams received from other sources, e.g., from a physical camera selected from list of physical cameras 410, or from a network connection to a remote computer system executing the same user application, to a display, such as display/keyboard combination 413. For example, if the well-known user application Microsoft Messenger were to select a virtual camera from the virtual camera list 414, the user interface presented by Microsoft Messenger would transparently include the processed and enhanced video containing content inserted by 3-D engine 420.

FIG. 5 is an exemplary virtual camera control user interface that may be used to control real-time 3-D tracking and real-time dynamic video content insertion in accordance with an exemplary embodiment of the present invention. As shown in FIG. 5, an exemplary virtual camera control user interface 500 may include a display screen 522 that displays an image 524 generated by the virtual camera and a display bar 526 that may display, for example, a text message 548 that is displayed along with the generated image 524, as well as other indicators, such as a connection status indicator 550 that indicates a connection status of an application receiving generated image 524.

Virtual camera control user interface 500 may also include a controls display 528 that allows a user to select from one or more virtual item display bars (e.g., 530 and 532) one or more virtual items (e.g., glasses 544 and hat 546) that may be applied to image 524. Controls display 528 may include a display bar 534 which may include one or more control features such as: email button 542, which allows a user to send an email containing, for example, 5 seconds of recorded virtual camera video images, to an individual or application receiving image 524; send text message button 540, which allows a user to insert text for display in text message 548 of generated image 524; access account button 536, which may be used to allow a user to purchase more virtual items (e.g., glasses 544 and hat 546), e.g., via an internet connection to a URL; and configuration button 533, which allows a user to set a variety of configuration parameters (e.g., screen size, screen colors, etc.). Controls display 528 may further include a control pad 538 that may include: left arrow/right arrow controls that allow a user to sequentially browse through the virtual items presented in virtual item display bars (e.g., 530 and 532) and to highlight (e.g., display enclosed within a box as shown with respect to virtual item 544) an individual virtual item; up arrow/down arrow controls to apply/remove a highlighted virtual item; and a center activation button, e.g., located between the left/right/up/down arrows on control pad 538. The center activation button may serve as a toggle to activate/deactivate special features associated with a virtual item applied to image 524. For example, the left/right arrows may be used to browse through the list of available virtual items until glasses 544 is highlighted in a box. Next, the up arrow may be used to apply/remove the glasses to/from image 524, and the center activation button my be used to turn on/off a video feature associated with the glasses, e.g., a video feature in which hearts and cupids are radiated from the glasses.

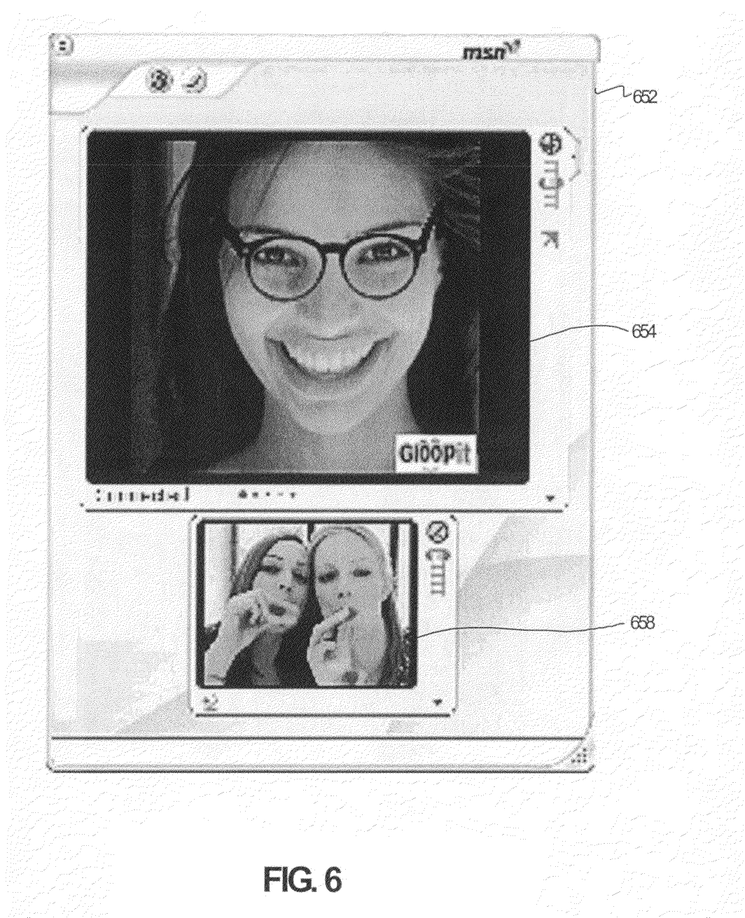

FIG. 6 is an exemplary user screen 652 presented by an exemplary video telephone user application (e.g., Microsoft Messenger) that includes a remote party video display 654 received from a remote party (e.g., via an Internet connection) as well as a local display 658 that displays a copy of the image sent to the remote party. As shown in FIG. 6, an output from a virtual camera, in use by a remote party, may be received and displayed in the same manner as an image received from a user transmitting output from a physical video camera; however, the image received from the virtual camera may include virtual items inserted by the remote party, such as the glasses shown in remote party video display 654.

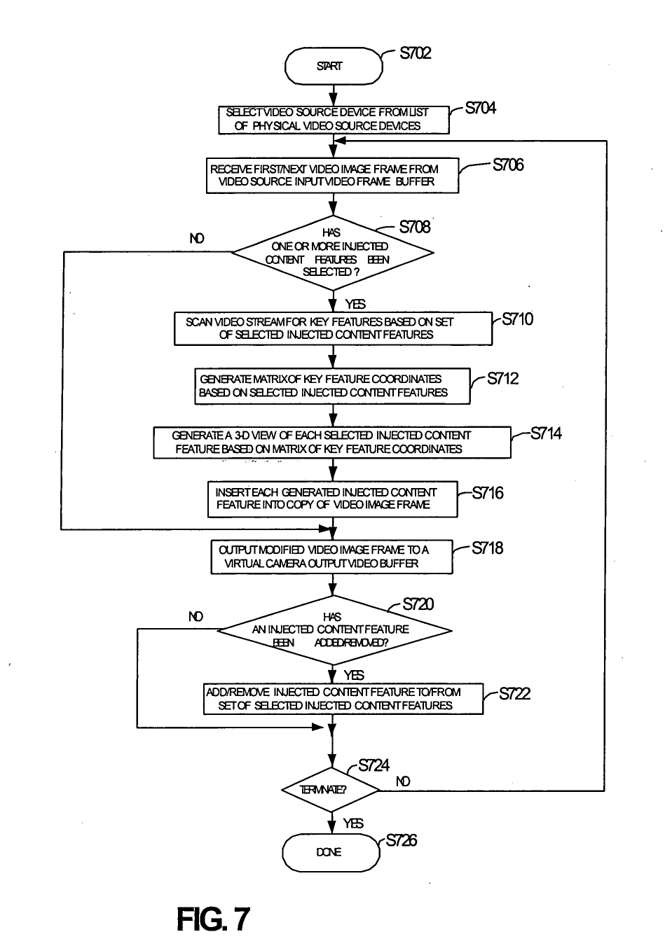

FIG. 7 is a flow diagram representing an exemplary method for generating a virtual camera video stream that includes real-time video content insertion, as may be performed by an exemplary computer system executing a virtual camera embodiment as described above with respect to FIG. 4. Such an exemplary virtual camera may support the ability to track one or more defined sets of three-dimensional coordinates associated with image content within a video stream and may allow virtual 3-D objects to be inserted within the video stream, on a real-time basis, based upon the tracked sets of 3-D coordinates.

As shown in FIG. 7, operation of the method begins at step S702 and proceeds to step S704.

In step S704, virtual camera 403 may be configured to receive one or more video streams from one or more physical video source devices, e.g., video cameras, video storage devices, etc., connected to computer system 401. For example, a user may select one or more defined physical video source devices defined in list of physical cameras 410 to associate the one or more physical video source devices with virtual camera 403, and operation proceeds to step S706.

In step S706, virtual camera controller 416 may receive a first, or next, video frame image from an associated physical camera via a physical camera video buffer associated with a physical video camera defined in list of physical cameras 410, and operation proceeds to step S708.

If, in step S708, the virtual camera controller determines that one or more injected content features has been selected for insertion within the physical video stream, operation proceeds to step S710, otherwise, operation proceeds to step S718.

In step S710, video camera controller 416 may invoke tracking engine 418 to scan the received video frame image for features within the video frame image that would support insertion of the one or more selected injected content features, and operation proceeds to step S712.

In step S712, tracking engine 418 may generate a matrix containing coordinates of key features within the video image frame associated with the selected injected content feature, and operation proceeds to step S714.

In step S714, video camera controller 416 may invoke 3-D-engine 420 to generate a 3-D view of injected content features based on the matrix of key feature coordinates produced in step S712, and operation proceeds to step S716.

In step S716, each generated 3-D view of an injected content feature generated in step S714, may be inserted into the video frame image based on the matrix of key feature coordinates produced in step S712, and operation proceeds to step S718.

In step S718, the generated virtual camera video frame image may be output from virtual camera controller 416 to a virtual camera buffer associated with a virtual camera defined within list of virtual cameras 414, and operation proceeds to step S720.

If, in step S720, the virtual camera controller determines that one or more injected content features has been added to and/or removed from the set of user selected features, operation proceeds to step S722, otherwise operation proceeds to step S724.

In step S722, injected content features may be added to and/or removed from a set of selected injected content features maintained by virtual camera controller 416 based on any number of factors, such as an explicit request for removal of a previously selected injected content item from a user, an explicit request for insertion of a new injected content item received from a user, a timeout associated with a previously selected injected content feature, etc., and operation proceeds to step S724.

If, in step S724, the virtual camera controller determines that virtual camera processing has been terminated by the user, operation terminates at step S726, otherwise, operation returns to step S706.

FIG. 8 presents a first computer system 801a and a second computer system 801b that may communicate with one another via a communication connection provided by network 830. For discussion purposes, computer system 801a and computer system 801b may be similarly configured with similar video camera hardware/software interfaces 806 each supporting a list of physical cameras, as described above with respect to FIG. 3 and FIG. 4, and each defined physical camera in the list may support a physical camera video buffer 810. Further, computer system 801a and computer system 801b may each include a virtual camera 805, that selects one or more physical cameras from the list of physical cameras, and thereby receives video frame images from a physical camera video buffer 810 associated with each selected physical camera.

Virtual camera 805 in each of computer system 801a and computer system 801b may output virtual camera video frame images to a virtual camera video buffer 814, each virtual camera video buffer 814 may be associated with a corresponding virtual camera in a list of virtual cameras made available to one or more user applications 812, as described above with respect to FIG. 3 and FIG. 4. Such user applications 812 may present one or more virtual camera video streams and/or real and/or virtual video streams received from other sources, e.g., from a physical camera selected from list of physical cameras 310, or from a network connection to a remote computer system executing the same user application, to a display, such as display/keyboard/other hardware device 813. In this manner virtual cameras 805 may be integrated within each of computer system 801a and computer system 801b in a manner similar to the virtual camera embodiments described above with respect to FIG. 3 and FIG. 4.

As shown in FIG. 8, virtual camera 805 may include a virtual camera controller 816, a feature tracking engine 818, a 3-D engine 820, and an encoding/decoding engine 817. As further shown in FIG. 8, the virtual camera controller 816 may connect to a camera 802 connected to the computer system via video camera hardware/software interface 806. Virtual camera controller 816 may then copy video frame images from the physical camera video buffer 810 and may send the video frame image to feature tracking engine 818. Feature tracking engine 818 may scan a video frame image for visual features related to a set of selected injected content and/or may scan a video audio track for spoken works and/or phrases that may be used to trigger additional injected content items into the video stream. Feature tracking engine 818 may return to virtual camera controller 816 a matrix of coordinates that may include coordinates within the video image frame for use in generating and inserting injected content into video frame images.

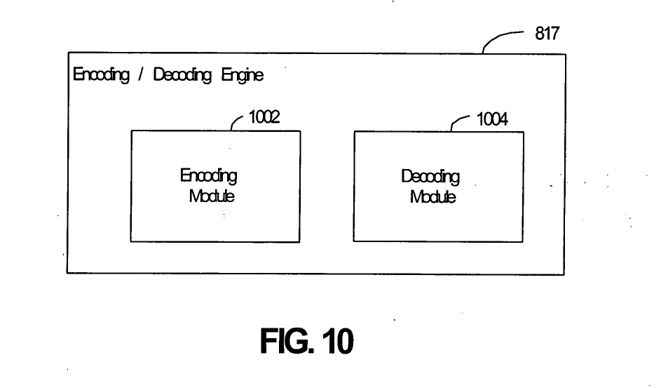

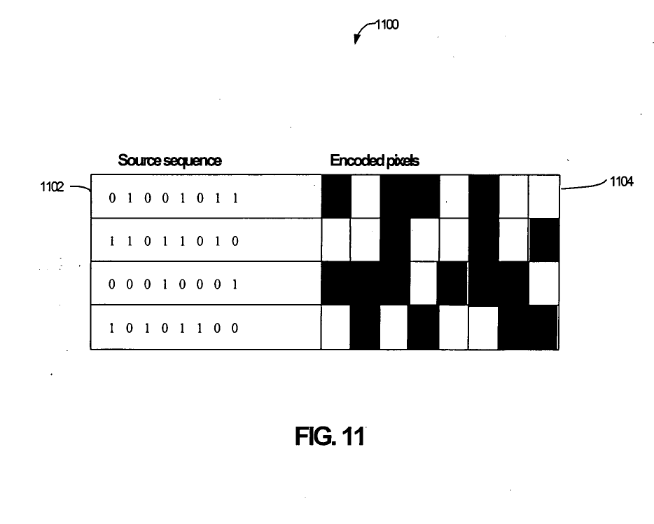

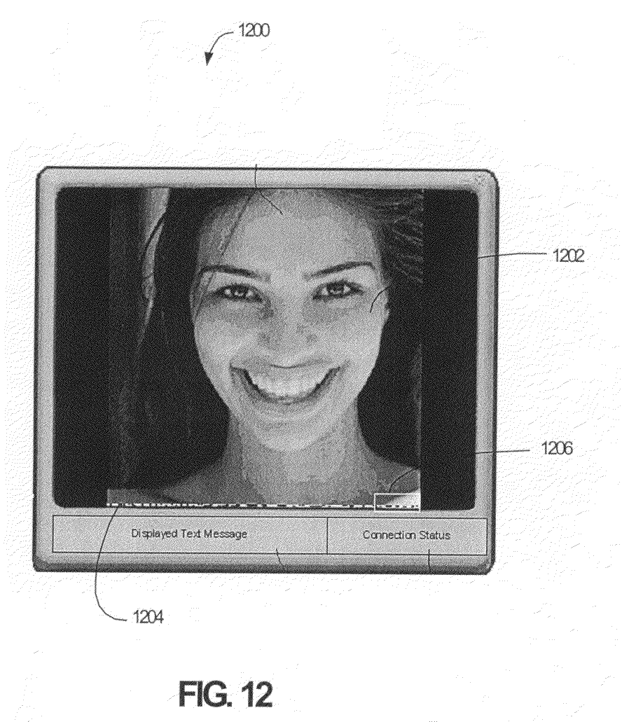

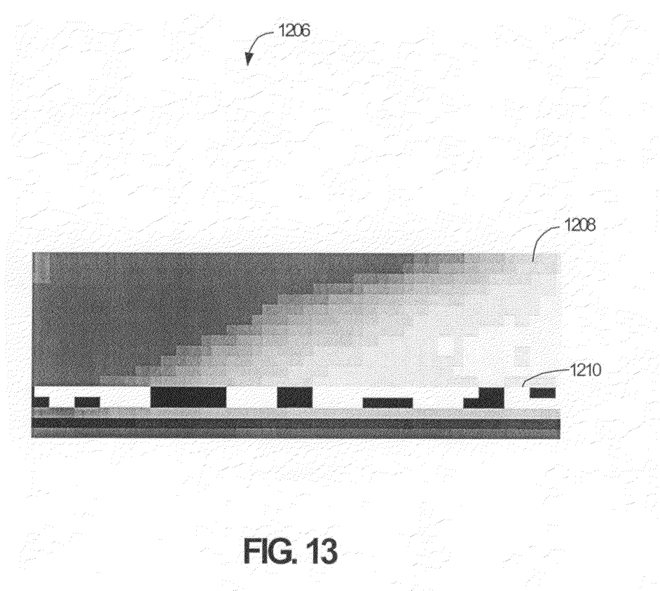

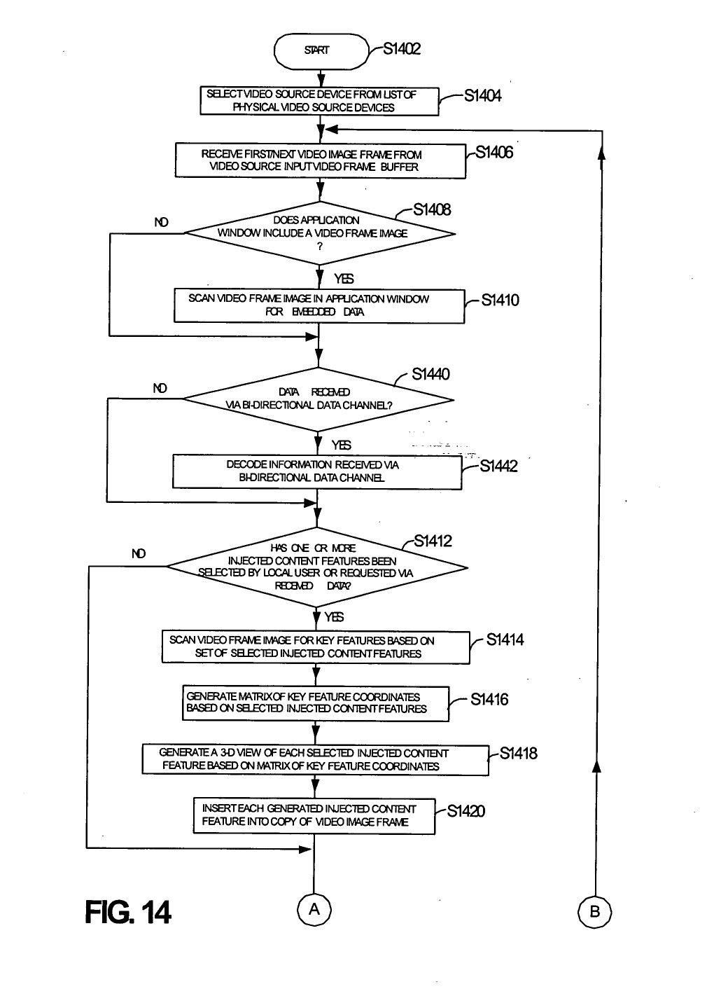

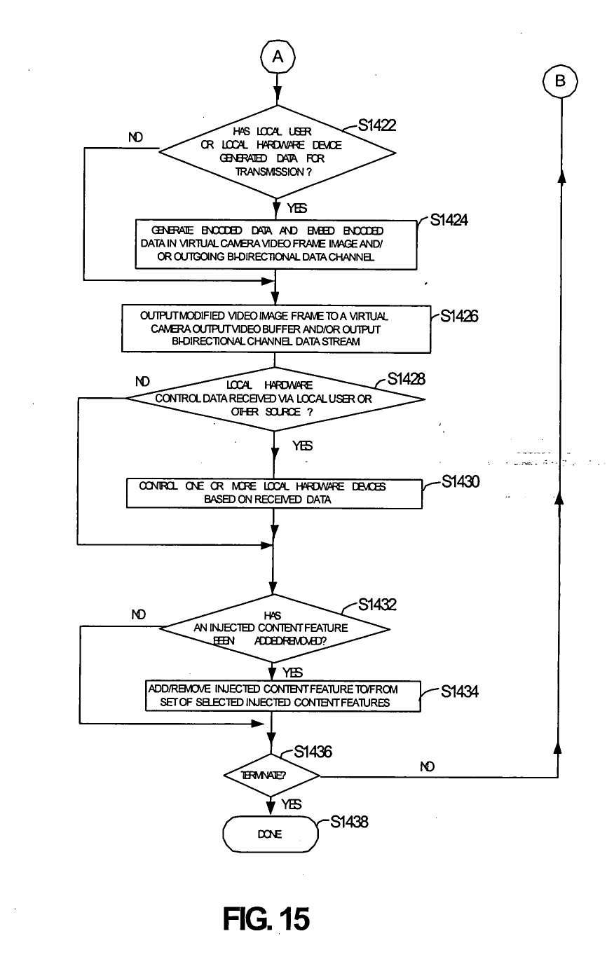

Next, virtual camera controller 816 may send the matrix of feature coordinates to the 3-D engine 820. Based on the features selected for insertion within the video, as described above with respect to FIG. 5, and the received feature coordinates matrix data, 3-D engine 820 may generate appropriate 3-D views of the selected injected content and may insert the generated content at an appropriate location within the respective video frame images received from physical camera video buffer 810. As described in greater detail with respect to FIG. 10, below, virtual camera controller may next pass instructions to encoding/decoding engine 817, resulting in either a group of encoded pixels that may be inserted into the respective video frame images of the virtual camera video stream in place of image pixels, or in an encoded data stream that may be transmitted between virtual camera embodiments executing on different computer systems connected by a network. Using such approaches, encoded information may be sent, in a manner that is transparent to user applications 812, from a virtual camera 805 operating on first computer system 801a to a virtual camera 805 operating on second computer system 801b as described in greater detail below with respect to FIG. 10. Next, virtual camera controller 816 may output the modified video stream to a virtual camera output video buffer 814 accessible to a user application 812.

Such user applications 812 may present one or more virtual camera video streams and/or other video streams received from other sources, e.g., from a physical camera selected from list of physical cameras 310, or from a network connection to a remote computer system executing the same user application, to a display, such as display/keyboard/other hardware device 813. In addition, a user application 812 may transmit the virtual camera video stream via network 830 to a corresponding user application 812 executing on a remote computer system 801b. As shown in FIG. 8, both computer system 801a and computer system 801b include a physical camera that is capable of providing user application 812 with a video stream from a physical camera. Further, both computer system 801a and computer system 801b may include a virtual camera that is capable of receiving and manipulating a video stream from one or more physical cameras to generate one or more virtual cameras that may also be presented to user application 812.

For example, both application 812 executing on computer system 801a and application 812 executing on computer system 801b may be configured to present a virtual camera stream to a user via local display/keyboard/other hardware device 813, transmit the virtual camera stream to user application 812 executing on a remote computer system via network 830 and to receive a virtual camera stream from a remote computer system via network 830. In such a configuration, virtual camera 816 executing on each of the respective network connected computer systems may generate a virtual camera video stream that includes injected content based on selections made by a local user via display/keyboard/other hardware device 813.

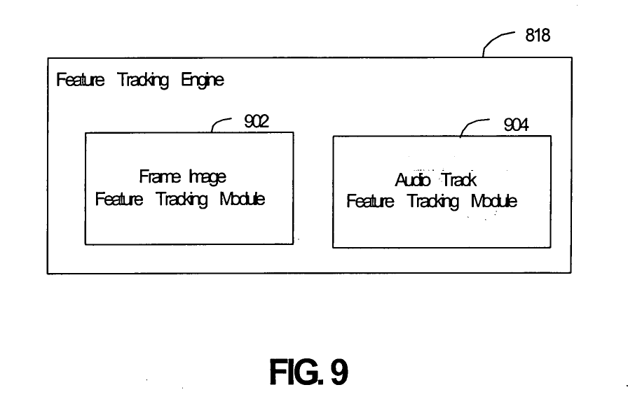

FIG. 9 is a schematic diagram of feature tracking engine 818 described above with respect to FIG. 8. As shown in FIG. 9, feature tracking engine 818 may include an frame image feature tracking module 902 and an audio track feature tracking module 904.

However, frame image feature tracking module 902 may support any number and type of injected content. For example, injected content may include modifications to a physical video stream that change and/or improve the appearance of an individual during a chat session. Such injected content may include the insertion of objects, such as glasses, hats, earrings, etc., but may also include image enhancement features, such as virtual makeup, in which the image is modified to improve an individual's appearance with, for example, lipstick, rosy cheeks, different colored eyes, different colored hair, virtual skin shining cream, virtual skin tanning cream, spot removal, wrinkle cream, teeth cleaner, etc. Such image content may be implemented, for example, by adjusting the tint of an identified facial feature and/or skin area, and/or by blurring and/or patching over a selected area of skin.

Frame image feature tracking module 902 may scan a video frame image to locate key pixel coordinates required to appropriately insert each selected injected content feature and may store the key pixel coordinates in a matrix of feature coordinates that may be passed by virtual camera controller 816 to 3-D engine 820. For example, for insertion of a virtual hat, frame image feature tracking module 902 may obtain and store coordinates associated with the top of an individual's head, eyes and ears; for insertion of virtual glasses, frame image feature tracking module 902 may obtain and store coordinates associated with eyes and ears; and for insertion of virtual lipstick, frame image feature tracking module 902 may obtain and store coordinates associated with an individuals lips. Each alteration of a video frame, such as correcting an individuals eye color, erasing a scar, and/or improving skin tone may each require a set of image coordinates and/or other parameters that may be collected by frame image feature tracking module 902 to support the selected injected content.

Audio track feature tracking module 904 may scan an audio track associated with a video stream to detect selected words and phrases. Once such phrases are located, audio track feature tracking module 904 may insert within the matrix of feature coordinates, coordinates for pre-selected injected content that may then be injected into the video stream and/or audio track. For example, on detecting a certain phrase, such as “I love you,” audio track feature tracking module 904 may add, within the matrix of feature coordinates, data that results in the insertion of injected features such as hearts beaming from an individuals eyes and/or may add data that results in the insertion of an additional audio track with pre-selected music and/or recorded phrases.

Audio track feature tracking module 904 may be configured to scan an audio track associated with an incoming video stream for any number of phrases, each phase may be associated with a predetermined action that results in an insertion of injected content into the video stream and/or audio stream. A user may configure virtual camera 805 with any number of phrases for which audio track feature tracking module 904 is to search and may configure virtual camera 805 with the injected content to be inserted on detection of the respective phrases.

As described above, exemplary virtual camera embodiment 805 may operate in a manner similar to the virtual camera embodiment 403 described above with respect to FIG. 4, but may be capable of inserting a wider range of injected content within a stream of video images produced for a virtual camera.

For example, as shown in FIG. 8, virtual camera embodiment 805 may further include encoding/decoding engine 817 that may be used to allow a first virtual camera associated with computer system 801 a to communicate with a second virtual camera associated with computer system 801b by either encoding information within individual video frame images, or encoding information within a separately transmitted data stream. For example, by encoding data within the video images shared between user applications, data may be transferred between virtual cameras executing on computer system 801a and 801b, respectively. Further, the data transfer may be performed transparently, i.e., without the knowledge of, the network hardware and/or software components over which the data is passed, and may further be performed in a manner that is transparent to the end user applications that receive the data encoded video frame images. Further, in addition to, or in place of, encoding data within virtual video frame images, one or more virtual camera embodiments may support a direct data communication path, or data communication channel, e.g., using TCP/IP or other communication protocol to establish data communication, with another virtual camera via network 830. As shown in FIG. 8, in such a virtual camera embodiment, a data communication channel may be established directly between an encoding/decoding engine 817 of a first executing virtual camera and an encoding/decoding engine 817 of a second executing virtual camera across network 830.

FIG. 10 is a schematic diagram of an encoding/decoding engine described above with respect to FIG. 8. As addressed above with respect to FIG. 8, encoding/decoding engine 817 may support a bi-directional exchange of information via LAN/WAN/Internet 830 between a first virtual camera 805 associated with a first computer system 801a and a second virtual camera 805 associated with a second computer system 801b. Such an exchange of information may be used to pass peer-to-peer information for any purpose, such as, for example, to pass control information that implements interactivity within an Interactive Video Space (IVS).

As addressed above, virtual camera embodiments may use a direct data communication channel to pass data between virtual camera embodiments executing on different communication systems connected via a network, and/or may embed data within a generated virtual camera video frame image passed between virtual camera embodiments executing on different communication systems connected via a network. In either embodiment, the transferred data may be used to embed any sort of information, including, hidden and/or encrypted text, control data for controlling virtual objects and/or other injected content, e.g., a ball, a thrown pie, etc., as addressed above, that may be added to a virtual camera video stream, and/or to control operation of a hardware device, e.g., a game controller, or other device, connected to a computer via a Universal Serial Bus (USB) or Bluetooth connection, that may react, e.g., move, vibrate, change position, etc., based on a received data stream. For example, transferred data used to control operation of a local hardware device may-include data related to the relative position of virtual objects, and/or real objects, tracked within the respective real camera video image streams and/or virtual camera video image streams exchanged between remote computer systems via network 830.

Further, a local hardware device controlled with encoded data embedded within a video frame image received by a local user application from a remote user application across network 830, or controlled with data received via a data communication channel between virtual cameras across network 830, may generate feedback data that may be encoded within a locally generated stream of virtual camera video frame images that may be returned by the local user application to the remote user application, or may generate feedback data that may be returned via the data communication channel between virtual cameras across network 830. In this manner, a bi-directional communication path may be established that allows a local hardware device to be effectively controlled by a remote computer system executing a remote virtual camera embodiment. For example, computer system 801a, shown in FIG. 8, may control and receive feedback from a hardware device connected to computer system 801b, and vice versa. Simultaneously, computer system 801b, shown in FIG. 8, may control and receive feedback from a hardware device connected to computer system 801a, and vice versa.

Via the interactive exchange of information, a user operating a first virtual camera executing on a first computer system 801a, may send a virtual object, such as a ball, cream pie, etc., over a network connection 830, and a second virtual camera executing on a second computer system 801b may be informed of the direction, speed and nature of the object, so that the virtual object may be included within the virtual camera video stream produced by the second virtual camera executing on the second computer system 801b.

For example, as described above, a virtual camera may receive a video stream from a local physical camera video buffer 810 and may insert injected content using 3-D engine 820 into the individual frames of a generated virtual camera video stream. Further, encoding/decoding engine 817 may encode information related to the virtual object, e.g., object type, speed, direction, etc., into the individual frames of a generated virtual camera video stream and the virtual camera video stream may be provided to a user application 812 via virtual camera video buffer 814, or encoding/decoding engine 817 may encode information related to the virtual object within a data stream transmitted by the virtual camera to another virtual camera via a data communication channel, e.g., using TCP/IP or other communication protocol. The locally produced virtual camera video stream may be sent by a locally executing user application 812 to the local user's display, and/or to locally connected hardware devices, and may be sent over network 830 to a user application executing on a remote computer which may display the virtual camera image stream to a remote user via a display of the remote computer system. Further, as described in greater detail, below, an encoding/decoding engine 817 within virtual camera 805, executing on a remote computer system, may process the received virtual camera frame images, and/or a data communication channel data stream, to extract encoded information and may use the extracted information to add corresponding injected content to the virtual video stream produced by the remote computer, and/or to control locally connected hardware devices based on the embedded information.

For example, using such a feature, a local user may send, in response to something said by the remote user during a chat session, an electronic cream pie that may be inserted into the virtual video stream produced by the remote user, sticks to the remote user's face and slowly slides down. In a similar manner, other virtual objects may be exchanged between both user's virtual worlds, thus allowing new types of interactive video chat games. For example, a local user could throw, e.g., head, a virtual soccer ball to a remote user and the remote user may either head the ball back, or if the ball is missed, a goal may be scored by the local user. Such a virtual game could be played amongst a plurality of users connected via the network. Similarly, a user may use such a feature to place a kiss on a remote user's face, and/or to insert any other type of injected content into the virtual video stream produced by the remote user application.

Further, using such a technique, a local user could ask a remote user to select on his computer a list of public information sites such a his favorite sports, friends, contacts etc., resulting in the creation of a virtual world around the remote user's face showing all the selected information sources with interactive hyper link icons, thereby allowing the local user to click on the icons to get details about the remote user.

As shown in FIG. 10, encoding/decoding engine 817 may include an encoding module 1002, and a decoding module 1004. Encoding module 1002 may be used to encode information within the pixels of the video frame images generated by 3-D engine 820 and/or may be used to encode information within a data stream passed data between virtual camera embodiments executing on different communication systems connected via a network.

As addressed above, virtual camera video images with embedded injected content, text messages and/or hardware device control data may be passed transparently between virtual camera 805 embodiments across network 830. Decoding module 1004 may be used to retrieve information encoded within a virtual camera video stream and may pass the retrieved information to virtual camera 816. Virtual camera controller 816 may use the information to insert corresponding injected content into a generated virtual camera video stream and/or to control hardware devices that may be connected to the computer system that receives the virtual camera video stream containing embedded information.

For example, to retrieve encoded data from a stream of virtual camera video frame images received by a local user application 812 from a remote user application 812, encoding/decoding engine 817 may be configured to monitor a user interface window used by the local user application to display a video stream received from a remote user application. On detecting that a new video frame image has been received within the monitored user interface window, encoding/decoding engine 817 may copy the video frame image. Decoding module 1004 of encoding/decoding engine 817 may then scan the video frame image to locate and decode data encoded within the video frame image. Decoded data retrieved by decoding module 1004 may be passed by encoding/decoding engine 817 to virtual camera controller 816.

For example, decoding module 1004 be provided with a string containing a user application window name. During operation, decoding module 1004 may find the window identified by the string and may analyze any image displayed within the designated window. If a video frame image contains encoded data, decoding module 1004 may extract the information contained within the encode buffer by parsing the pixels of the image frame. For example, binary data may be stored in the image based on pixel color: a black pixel (RGB 0, 0, 0) may be interpreted as a binary 0, while a white or gray pixel (RGB×>0,×>0,×>0) may be interpreted as a binary 1. Decoding may be a continuous procedure that may detect and decode information from the respective video frames images at the frame rate of the received video stream, or higher. Decoded information may be passed to the virtual camera controller 816 for use in controlling injected 3-D content and/or text inserted into a locally generated virtual camera video stream, and/or for use in controlling a locally connected hardware device.

FIG. 11 presents an exemplary pixel encoding technique that may be used by encoding module 1002 to encode information in a portion of one or more video frame images within a video stream generated by the virtual camera embodiments described above with respect to FIGS. 8-10. For example, each encoded pixel can have one of two colors: black or white (gray). Color selection depends on the data within the buffer that is encoded. If a corresponding bit of encoded buffer is set to 0, the resulting encoded pixel color may be black; if a corresponding bit of encoded buffer is set to 1, the resulting encoded pixel color may be white.

FIG. 12 presents an exemplary view 1200 of a generated virtual camera video frame image 1202 that includes an encoded data portion 1204 within a two-pixel frame located at the base of the image. In such an encoding embodiment, assuming that the image size is fixed to 320×240 and that the image buffer is stored in a format in which one pixel is represented with four bits, the encoded portion of the video frame image may include 320 bytes of encoded information. However, depending on the number of bits associated with each pixel in the selected image format and the area of the image designated for storing encoded data, the number of bytes of encoded information included within a video stream may be significantly changed. For example, in one embodiment, larger portions of the video image may be used for embedded data. In another embodiment, frames containing embedded data may be dispersed among frames that do not include embedded data, thereby reducing the visual impact of the encoded data on the image presented to a user.

For example, in one embodiment, encoding data within a generated virtual camera video frame image may be performed by a Win32 dynamic link library (DLL) that limits the image size to 320×240. Image encoding may add a two-pixel border around of the image containing black and white pixels that represent encoded data, as described above. In such an exemplary embodiment, the length of the encoded buffer may be based on a count of pixels in the border of encoded image. For example, in one embodiment, the encoded buffer size may be calculated by the formula 320*4+236*4−8−32=2184 bits or 273 bytes. In the above calculation, 8 bits may be reserved, i.e., subtracted from the encoded buffer size, for use in transmitting an eight-bit fixed signature, and 32 bits may be reserved, i.e., subtracted from the encoded buffer size, for use in transmitting a dynamically generated checksum based on the contents of the encoded buffer.

For example, in another embodiment, the encoded data included within a selected image format, e.g., MPEG, or other image format, such that the transferred image is not affected by the encoded data, but the encoded data remains transparent to the user application receiving the video frame image containing the encoded data.

Further, detecting and decoding a data buffer encoded within a generated virtual camera video frame image may also be performed by a Win32 dynamic link library (DLL). For example, an exemplary Win32 Unicode DLL may receive a string containing a user application window name, may find the window and may analyze any image displayed within the designated window. If a video frame image contains encoded data, the decoder may extract the information contained within the encode buffer by parsing the pixels of the image frame. For example, as addressed above, binary data may be stored in the image based on pixel color: a black pixel (RGB 0, 0, 0) may be interpreted as a binary 0, while a white or gray pixel (RGB×>0,×>0,×>0) may be interpreted as a binary 1. Decoding may be a continuous procedure that may detect and decode information from the respective video frames images at the frame rate of the received video stream, or higher. Decoded information may be passed to the virtual camera controller for use in controlling injected 3-D content and/or text inserted into a locally generated virtual camera video stream, and/or for use in controlling a locally connected hardware device.

FIG. 13 presents a detailed view of a portion 1206 of exemplary view 1200 presented in FIG. 12, above. As shown in FIG. 13, view portion 1206 contains a portion 1208 of virtual camera video frame image 1202 as well as a portion 1210 of encoded data portion 1204 shown in FIG. 12.

FIGS. 14 and 15 are a flow diagram that present an exemplary process that may be performed by a virtual camera embodiment that supports a bi-directional data interface, as described above with respect to FIG. 8-13. As described above with respect to FIG. 4, a virtual camera may support the ability to track one or more defined sets of three-dimensional coordinates associated with image content within a video stream and may allow virtual 3-D objects to be inserted within the video stream, on a real-time basis, based upon the tracked sets of 3-D coordinates. As described above with respect to FIGS. 8-13, virtual camera embodiments that support a bi-directional data interface may support a wide range of interactive capabilities that allow injected content and characteristics to be controllably passed across virtual camera video streams in support of interactive gaming. Further, such a bi-directional interface may also be used to support the simultaneous control an operation of local hardware devices by computer systems at remote locations connected via a network, based on the relative position of objects dynamically tracked features within virtual camera and/or physical camera video streams.

As shown in FIGS. 14 and 15, operation of the method begins at step S1402 and proceeds to step S1404.

In step S1404, virtual camera 805 may be configured to receive one or more video streams from a physical video camera connected to computer system 801A. For example, a user may select one or more physical video cameras defined in list of physical cameras to assign one or more physical video buffers 810 as a physical video stream sources for virtual camera 805, and operation proceeds to step S1406.

In step S1406, virtual camera controller 816 may receive a first, or next, video frame image from an associated physical camera video buffer, and operation proceeds to step S1408.

If, in step S1408, the virtual camera controller determines that a user application window monitored by encoding/decoding engine 817 has received a video frame image from a user application 812, operation proceeds to step S1410, otherwise, operation proceeds to step S1412.

In step S1410, video camera controller 816 may invoke encoding/decoding engine 817 to scan the video frame image received in an assigned user application window for data encoded within the video frame image, and operation proceeds to step S1440.

If, in step S1440, the virtual camera controller determines that data has been received on a bi-directional communication channel supported by the virtual camera, operation proceeds to step S1442, otherwise, operation proceeds to step S1412.

In step S1442, video camera controller 816 may invoke encoding/decoding engine 817 to decode information received via the bi-directional communication channel, and operation proceeds to step S1412.

If, in step S1412, the virtual camera controller determines that one or more injected content features has been selected for insertion within the physical video stream via either a local user selection or via data encoded within a received video frame image or via data encoded within a received data stream, operation proceeds to step S1414, otherwise, operation proceeds to step S1422.

In step S1414, video camera controller 816 may invoke tracking engine 418 to scan a physical camera video image frame received via physical camera video buffer 810 for features within the video frame image based on the one or more selected injected content features, and operation proceeds to step S1416.

In step S1416, tracking engine 818 may generate a matrix containing coordinates of key features within the video image frame associated with the selected injected content feature, and operation proceeds to step S1418.

In step S1418, video camera controller 816 may invoke 3-D engine 820 to generate a 3-D view of injected content features based on the matrix of key feature coordinates produced in step S1416, and operation proceeds to step S1420.

In step S1420, each generated 3-D view of an injected content feature generated in step S1416, may be inserted into the video frame image based on the matrix of key feature coordinates produced in step S1416, and operation proceeds to step S1422.

If, in step S1422, virtual camera controller 816 determines, e.g., based on local user input, based on a result of an automated process, based on feedback received from a local hardware device controlled with embedded data received within a received video image, etc., that data has been generated that requires transmission to a remote virtual camera executing on a remote computer system, operation proceeds to step S1424, otherwise, operation proceeds to step S1426.

In step S1424, data to be transferred to a remote virtual camera via network 830 is encoded and embedded in the virtual camera video frame image and/or outgoing bi-directional channel data stream, as described above, and operation proceeds to step S1426

In step S1426, a generated virtual camera video frame image may be output from virtual camera controller 816 to a virtual camera buffer 814 accessible by a user application 812, and any outgoing bi-directional channel data may be transmitted over the network, and operation proceeds to step S1428.

If, in step S1428, the virtual camera controller determines that control data has been received as a result of local user input and/or via data received from a virtual camera executing on a remote user computer system, e.g., embedded within a video frame image, received via the bi-directional communication channel, etc., operation proceeds to step S1430, otherwise operation proceeds to step S1432.

In step S1430, virtual camera controller initiates control of the one or more local hardware devices based the received control data, and operation proceeds to step S1432.

If, in step S 1432, the virtual camera controller determines that one or more injected content features has been added to and/or removed from the set of user selected features, operation proceeds to step S1434, otherwise operation proceeds to step S1436.

In step S1434, injected content features may be added to and/or removed from the set of selected injected content features based on any number of factors, such as an explicit request for removal of a previously selected injected content item from a user, an explicit request for insertion of a new injected content item received from a user, a timeout associated with a previously selected injected content feature, embedded data received in a video frame image, data received via the bi-directional communication channel, etc., and operation proceeds to step S1436.

If, in step S1436, the virtual camera controller determines that virtual camera processing has been terminated by the user, operation terminates at step S1438, otherwise, operation returns to step S1406.

It will be appreciated that the exemplary embodiments described above and illustrated in the drawings represent only a few of the many ways of implementing a hardware independent virtual camera and real-time video coordinate tracking and content insertion approach. The present invention is not limited to use within any specific network, but may be applied to any deployed network infrastructure that supports video based user applications.

The described hardware independent virtual camera and real-time video coordinate tracking and content insertion approach may be implemented in any number of hardware and software modules and is not limited to any specific hardware/software module architecture. Each module may be implemented in any number of ways and is not limited in implementation to execute process flows precisely as described above.

It is to be understood that various functions of the described hardware independent virtual camera and real-time video coordinate tracking and content insertion approach may be distributed in any manner among any quantity (e.g., one or more) of hardware and/or software modules or units, computer or processing systems or circuitry.

The described hardware independent virtual camera and real-time video coordinate tracking and content insertion approach may be integrated within a stand-alone system or may execute separately and be coupled to any number of devices, computer systems, server computers or data storage devices via any communication medium (e.g., network, modem, direct connection, etc.). The described hardware independent virtual camera and real-time video coordinate tracking and content insertion approach can be implemented by any quantity of devices and/or any quantity of personal or other type of computers or processing systems (e.g., IBM-compatible, Apple, Macintosh, laptop, palm pilot, microprocessor, etc.). The computer system may include any commercially available operating system (e.g., Windows, OS/2, Unix, Linux, DOS, etc.), any commercially available and/or custom software (e.g., communication software, traffic analysis software, etc.) and any types of input/output devices (e.g., keyboard, mouse, probes, I/O port, etc.).

For example, embodiments of the described virtual camera may be executed on one or more servers that communicate with end-user devices, such a third-generation portable telephones or other devices, via a network. In such an embodiment, streams of video frame images and data between the respective virtual camera devices may be transferred internally within a single server, or between the two servers over a network. In such exemplary embodiments encoded data may be transferred between two virtual camera embodiments directly, possibly without the need to embed bi-directional interface data within a virtual video frame image transferred transparently by user applications.

Control software, or firmware, for the described hardware independent virtual camera and real-time video coordinate tracking and content insertion approach may be implemented in any desired computer language, and may be developed by one of ordinary skill in the computer and/or programming arts based on the functional description contained herein and illustrated in the drawings. For example, in one exemplary embodiment the described system may be written using the C++ programming language and the Microsoft DirectX/DirectShow software development environment. However, the present invention is not limited to being implemented in any specific programming language. The various modules and data sets may be stored in any quantity or types of file, data or database structures. Moreover, the software associated with the described hardware independent virtual camera and real-time video coordinate tracking and content insertion approach may be distributed via any suitable medium (e.g., stored on devices such as CD-ROM and diskette, downloaded from the Internet or other network (e.g., via packets and/or carrier signals), downloaded from a bulletin board (e.g., via carrier signals), or other conventional distribution mechanisms).

The format and structure of internal information structures used to hold intermediate information in support of the described hardware independent virtual camera and real-time video coordinate tracking and content insertion approach, may include any and all structures and fields and are not limited to files, arrays, matrices, status and control booleans/variables.

The described hardware-independent virtual camera and real-time video coordinate tracking and content insertion approach may be installed and executed on a computer system in any conventional or other manner (e.g., an install program, copying files, entering an execute command, etc.). The functions associated with the described system may be performed on any quantity of computers or other processing systems. Further, the specific functions may be assigned to one or more of the computer systems in any desired fashion.

The described hardware independent virtual camera and real-time video coordinate tracking and content insertion device may accommodate any quantity and any type of data set files and/or databases or other structures containing stored data sets, measured data sets and/or residual data sets in any desired format (e.g., ASCII, plain text, any word processor or other application format, etc.).

Further, any references herein to software performing various functions generally refer to computer systems or processors performing those functions under software control. The computer system may alternatively be implemented by hardware or other processing circuitry. The various functions of the described hardware independent virtual camera and real-time video coordinate tracking and content insertion approach may be distributed in any manner among any quantity (e.g., one or more) of hardware and/or software modules or units, computers or processing systems or circuitry. The computer or processing systems may be disposed locally or remotely of each other and communicate via any suitable communication medium (e.g., LAN, WAN, Intranet, Internet, hardwire, modem connection, wireless, etc.). The software and/or processes described above may be modified in any manner that accomplishes the functions described herein.

From the foregoing description, it will be appreciated that a hardware-independent virtual camera and real-time video coordinate tracking and content insertion device is disclosed. The described approach is compatible and may be seamlessly integrated within existing video camera and computer system equipment.

While a method and apparatus are disclosed that provide a hardware independent virtual camera that may be seamlessly integrated within existing video camera and computer system equipment, various modifications, variations and changes are possible within the skill of one of ordinary skill in the art, and fall within the scope of the present invention. Although specific terms are employed herein, they are used in their ordinary and accustomed manner only, unless expressly defined differently herein, and not for purposes of limitation.

What is claimed is:

1. A method of generating a stream of virtual camera video frame images, comprising:
receiving a stream of video frame images from an input video frame buffer connected to a video source;
locating one or more features within a video frame image of the received stream of video frame images based on an injected content feature selected for insertion within the received stream of video frame images;
generating a set of three-dimensional coordinates that contains three-dimensional coordinates for the one or more located features;
generating a three-dimensional image of the selected injected content feature based on the generated set of three-dimensional coordinates;
inserting the generated three-dimensional image into the received video frame image based on the set of three-dimensional coordinates to generate a virtual camera video frame image; and
outputting the virtual camera video frame image to a virtual camera video frame output buffer.

2. The method of claim 1, further comprising:
updating the generated set of three-dimensional coordinates based on changes in image content of a next received video frame image within the received stream of video frame images, thereby tracking a position of the one or more located features;
updating the generated three-dimensional image of the selected injected content feature based on the updated set of three-dimensional coordinates; and
inserting the updated three-dimensional image into the next received video frame image.

3. The method of claim 1, further comprising:
receiving input via a local user input device that one of selects and de-selects an injected content feature for insertion within the received stream of video frame images.

4. The method of claim 1, wherein the video source is selected from a list identifying one or more available video sources.

5. The method of claim 1, wherein the video source is a physical camera that supplies a stream of video frame images to the input video frame buffer.

6. The method of claim 1, wherein the video source is a storage device that supplies a stream of video frame images to the input video frame buffer.

7. The method of claim 1, wherein the video source supplies a stream of video to a input video frame buffer via a device specific driver tailored to the hardware or software characteristics of the video source.

8. The method of claim 1, wherein the virtual camera video frame output buffer is selected from a list of virtual cameras as a video source for a user application.

9. The method of claim 1, further comprising:
controlling operation of a local hardware device based on changes in the tracked position of the one or more located features within the stream of video frame images received from the input video frame buffer.

10. The method of claim 9, wherein the local hardware device is a video game input/output device.

11. The method of claim 1, wherein the stream of video frame images received from the input video frame buffer originates from a video source connected to the input video frame buffer via a network.

12. The method of claim 1, further comprising:
monitoring a user interface window within a user application to detect a video frame image from an external source;
scanning a portion of the detected video frame image to locate a data encoded portion of the video frame image; and
decoding the data encoded portion of the video frame image to retrieve data encoded within the video frame image.

13. The method of claim 12, further comprising:
adding or removing a injected content feature to/from the virtual camera video stream based on data decoded from the video frame image received from the external source.

14. The method of claim 13, further comprising:
assigning characteristics to the injected content feature inserted within the virtual camera video stream based on data decoded from the video frame image received from the external source.

15. The method of claim 12, further comprising:
controlling a local hardware device based on data decoded from the video frame image received from the external source.

16. The method of claim 15, wherein the local hardware device is a video game input/output device.

17. The method of claim 1, further comprising:
establishing a data communication channel with a remote virtual camera over a network;
sending data to the remote virtual camera via the data communication channel; and
receiving data from the remote virtual camera via the data communication channel.

18. The method of claim 17, further comprising:
assigning characteristics to the injected content feature inserted within the virtual camera video stream based on data received via the data communication channel.

19. The method of claim 17, further comprising:
controlling a local hardware device based on data received via the data communication channel.

20. The method of claim 19, wherein the data sent to the remote virtual camera via the data communication channel includes data generated by the controlled local hardware device.

21. A virtual video camera, comprising:
a virtual camera controller that receives a stream of video frame images from an input video frame buffer connected to a video source and transmits a generated stream of virtual camera video frame images to a virtual camera video frame output buffer;
a tracking engine that locates one or more features within a video frame image of the received stream of video frame images based on an injected content feature selected for insertion within the received stream of video frame images, and generates a set of three-dimensional coordinates that contains three-dimensional coordinates for the one or more located features; and
a 3-D engine that generates a three-dimensional image of the selected injected content feature based on the generated set of three-dimensional coordinates, and inserts the generated three-dimensional image into the received video frame image based on the set of three-dimensional coordinates to generate the virtual camera video frame image.

22. The virtual video camera of claim 21,
wherein the tracking engine updates the generated set of three-dimensional coordinates based on changes in image content of a next received video frame image within the received stream of video frame images, thereby tracking a position of the one or more located features, and updates the generated three-dimensional image of the selected injected content feature based on the updated set of three-dimensional coordinates, and
the 3-D engine inserts the updated three-dimensional image into the next received video frame image.

23. The virtual video camera of claim 21, wherein the virtual camera controller receives input via a local user input device that one of selects and de-selects an injected content feature for insertion within the received stream of video frame images.

24. The virtual video camera of claim 21, wherein the video source is selected from a list identifying one or more available video sources.

25. The virtual video camera of claim 21, wherein the video source is a physical camera that supplies a stream of video frame images to the input video frame buffer.

26. The virtual video camera of claim 21, wherein the video source is a storage device that supplies a stream of video frame images to the input video frame buffer.

27. The virtual video camera of claim 21, wherein the video source supplies a stream of video to a input video frame buffer via a device specific driver tailored to the hardware or software characteristics of the video source.

28. The virtual video camera of claim 21, wherein the virtual camera video frame output buffer is selected from a list of virtual cameras as a video source for a user application.

29. The virtual video camera of claim 21, wherein the virtual camera controller controls operation of a local hardware device based on changes in the tracked position of the one or more located features within the stream of video frame images received from the input video frame buffer.

30. The virtual video camera of claim 29, wherein the local hardware device is a video game input/output device.

31. The virtual video camera of claim 21, wherein the stream of video frame images received from the input video frame buffer originates from a video source connected to the input video frame buffer via a network.

32. The virtual video camera of claim 21, further comprising:
an encoding/decoding engine that monitors a user interface window within a user application to detect a video frame image from an external source, scans a portion of the detected video frame image to locate a data encoded portion of the video frame image, and decodes the data encoded portion of the video frame image to retrieve data encoded within the video frame image.

33. The virtual video camera of claim 32, wherein the virtual camera controller adds or removes an injected content feature to/from the virtual camera video stream based on data decoded from the video frame image received from the external source.

34. The virtual video camera of claim 33, wherein the virtual camera controller assigns characteristics to the injected content feature inserted within the virtual camera video stream based on data decoded from the video frame image received from the external source.

35. The virtual video camera of claim 32, wherein the virtual camera controller controls a local hardware device based on data decoded from the video frame image received from the external source.

36. The virtual video camera of claim 35, wherein the local hardware device is a video game input/output device.

37. The virtual video camera of claim 21, further comprising:
a bi-directional data communication channel with a remote virtual camera over a network that is used to send data to the remote virtual camera via the data communication channel and to receive data from the remote virtual camera via the data communication channel.

38. The virtual video camera of claim 37, wherein the virtual camera assigns characteristics to the injected content feature inserted within the virtual camera video stream based on data received via the data communication channel.

39. The method of claim 37, wherein the virtual camera controls a local hardware device based on data received via the data communication channel.

40. The method of claim 39, wherein the data sent to the remote virtual camera via the data communication channel includes data generated by the controlled local hardware device.
